(19) United States
(12) Patent Application Publication
(10) Pub. No.: US 2022/0311129 A1
(43) Pub. Date: Sep. 29, 2022

(54) Transmitting Antenna System, Receiving Antenna System and Communication Device

(71) Applicant: BOE Technology Group Co., Ltd., Beijing (CN)

(72) Inventors: Tao LI, Beijing (CN); Genyu LIU, Beijing (CN); Xingqun JIANG, Beijing (CN); Jun YANG, Beijing (CN); Quanzhong WANG, Beijing (CN); Chao YU, Beijing (CN)

(21) Appl. No.: 17/418,864

(22) PCT Filed: Dec. 29, 2020
(86) PCT No.: PCT/CN2020/140886

§ 371 Date: Jun. 28, 2021

(30) Foreign Application Priority Data
Feb. 21, 2020 (CN) 202010110388.6

(51) Int. Cl. H01Q 1/24; H01Q 21/29; H01Q 3/26; H01Q 5/20; H01Q 9/30

(52) U.S. Cl. CPC H01Q 1/246; H01Q 21/29; H01Q 3/26; H01Q 5/20; H01Q 9/30

(57) ABSTRACT

Provided is a transmitting antenna system, which includes an omnidirectional antenna and a phased array antenna, wherein a phased array antenna includes a plurality of antenna arrays which are disposed on the circumference with an omnidirectional antenna as the center, and the interval between any two adjacent antenna arrays is the same. The present disclosure also provides a receiving antenna system and a communication device.

The present application claims the priority of the Chinese patent application No. 202010110388.6, entitled “Transmitting Antenna System, Receiving Antenna System and Communication Device”, filed to the CNIPA on Feb. 21, 2020, the content of which should be interpreted as being incorporated into the present application by reference.

### TECHNICAL FIELD

The present disclosure relates to, but is not limited to, the technical field of wireless communication, in particular to a transmitting antenna system, a receiving antenna system and a communication device.

### BACKGROUND

Nowadays, wireless communication technology is widely used in various scenarios. In some application scenarios of wireless communication, the data synchronization between the receiver and the transmitter of wireless signals is often affected by the interference of complex electromagnetic environment or malicious co-channel interference.

### SUMMARY

The following is a summary of subject matter described in detail herein. This summary is not intended to limit the protection scope of the claims.

The present disclosure provides a transmitting antenna system, a receiving antenna system and a communication device.

In one aspect, the present disclosure provides a transmitting antenna system, which includes an omnidirectional antenna and a phased array antenna, wherein the phased array antenna includes a plurality of antenna arrays which are disposed on the circumference centered on the omnidirectional antenna, and the interval between any two adjacent antenna arrays is the same.

In another aspect, the present disclosure provides a communication device including the aforementioned transmitting antenna system.

In another aspect, the present disclosure provides a receiving antenna system, which includes at least one antenna, at least one amplifier and at least one receiver; the antenna, the amplifier and the receiver are connected in one-to-one correspondence, the antenna is connected to an input of the amplifier, and an output of the amplifier is connected to the receiver; wherein the noise figure of the amplifier is smaller than that of the receiver.

In another aspect, the present disclosure provides a communication device including the aforementioned receiving antenna system.

Other aspects will become apparent upon reading and understanding accompanying drawings and the detailed description.

### BRIEF DESCRIPTION OF DRAWINGS

Accompanying drawings are used to provide an understanding of technical solutions of the present disclosure and form a part of the specification. Together with embodiments of the present disclosure, they are used to explain technical solutions of the present disclosure but do not constitute a limitation on the technical solutions of the present disclosure.

FIG. 1 is a schematic diagram of a transmitting antenna system according to an embodiment of the present disclosure.

FIG. 2 is a schematic top view of a transmitting antenna according to an embodiment of the present disclosure.

FIG. 3 is a schematic principle diagram of a phased array antenna according to an embodiment of the present disclosure.

FIG. 4 is a schematic diagram of a communication device according to an embodiment of the present disclosure.

FIG. 5 is a schematic diagram of a receiving antenna system according to an embodiment of the present disclosure.

FIG. 6 is a schematic diagram of another communication device according to an embodiment of the present disclosure.

FIG. 7 is a schematic diagram of antenna directivity coverage of a transmitting antenna system in an application scenario according to an embodiment of the present disclosure.

### DETAILED DESCRIPTION

A plurality of embodiments are described in the present disclosure, but the description is exemplary rather than restrictive, and it is apparent to those of ordinary skills in the art that there may be more embodiments and implementation solutions within the scope of the embodiments described in the present disclosure. Although many possible combinations of features are shown in the drawings and discussed in the embodiments, many other combinations of the disclosed features are also possible. Unless specifically limited, any feature or element of any embodiment may be used in combination with or in place of any other feature or element of any other embodiment.

The present disclosure includes and contemplates combinations of features and elements known to those of ordinary skilled in the art. The disclosed embodiments, features and elements of the present disclosure may be combined with any conventional features or elements to form a unique scheme defined by the claims. Any feature or element of any embodiment may also be combined with features or elements from other schemes to form another unique scheme defined by the claims. Therefore, it should be understood that any of the features shown and discussed in the present disclosure may be implemented individually or in any suitable combination. Therefore, the embodiments are not otherwise limited except in accordance with the appended claims and equivalents thereof. In addition, one or more modifications and alterations may be made within the protection scope of the appended claims.

Furthermore, when describing representative embodiments, the specification may have presented a method or process as a specific order of acts. However, to the extent that the method or process does not depend on the specific order of steps described herein, the method or process should not be limited to the specific order of steps described. As those of ordinary skills in the art will understand, other orders of steps are also possible. Therefore, the specific order of steps set forth in the specification should not be interpreted as limiting the claims. Furthermore, the claims for the method or process should not be limited to performing the acts in the order of its acts, and those skilled in the art can easily understand that these orders may be varied but still remain within the essence and scope of the embodiments of the present disclosure.

In the drawings, size of one or more constituent elements, or thickness or area of a layer, is sometimes exaggerated for clarity. Therefore, an implementation of the present disclosure is not necessarily limited to the size shown, and a shape and size of each component in the drawings do not reflect true proportions. In addition, the drawings schematically show ideal examples, and an implementation of the present disclosure is not limited to the shapes or values shown in the drawings.

Unless otherwise defined, technical terms or scientific terms used in the present disclosure shall have ordinary meanings understood by those of ordinary skills in the art to which the present disclosure belongs. The words “first”, “second” and the like used in the present disclosure do not indicate any order, quantity or importance, but are only used to distinguish different components. In the present disclosure, “a plurality of” may mean two or more than two.

In order to make the following description of the embodiments of the present disclosure clear and concise, detailed description of some of known functions and known components are omitted in the present disclosure. The drawings of the embodiments of the present disclosure only relate to structures involved in the embodiments of the present disclosure, and for other structures, general designs may be referred to.

Nowadays, in some wireless communication application scenarios, the receiver and transmitter of wireless signals cannot establish reliable wireless transmission in a complex environment. For example, when thousands of display devices are controlled by a wireless base station at a large-scale banquet or party venue, it is impossible to guarantee that each display device can receive the signals from wireless base stations simultaneously and reliably to perform corresponding operations due to complex electromagnetic environment or malicious co-channel interference. For example, the signals transmitted by a wireless base station are easily interfered by other co-channel transmitters, which degrade the reception performance of display devices, and the numerous display devices that cannot receive signals transmitted by the wireless base station makes it impossible for the display contents to synchronize on display devices. In addition, a display device can be easily blocked by signals outside the receiving bandwidth, which causes a saturation of reception as well as a degradation of reception performance. Moreover, when display devices are scattered around a wireless base station, it is easy for those display devices that are far from the wireless base station to lose the transmitted signals due to the long distance.

Embodiments of the present disclosure provide a transmitting antenna system, a receiving antenna system and a communication device. By utilizing a transmitting antenna system that combines both an omnidirectional antenna and a phased array antenna, the wireless communication distance and directionality are optimized, and by connecting an amplifier after the receiving antenna, the receiving sensitivity of the wireless signal receiver is improved, thereby improving the reliability of wireless communication between a transmitter and a receiver of the wireless signal.

The embodiment of the disclosure provides a transmitting antenna system, which includes an omnidirectional antenna and a phased array antenna, wherein a phased array antenna includes a plurality of antenna arrays which are disposed on the circumference with an omnidirectional antenna as the center, and the interval between any two adjacent antenna arrays is the same. For example, the phased array antenna includes N antenna arrays, and any two antenna arrays are evenly distributed on the circumference centered on the omnidirectional antenna at an interval of 360/N degrees, where N is an integer greater than 1.

In this embodiment, the phased array antenna refers to an antenna whose direction and pattern shape are changed by controlling the infeed phase of the radiation unit in the array antenna. By controlling the phase, the maximum direction of the antenna pattern may be changed to achieve the purpose of transmitting signals in different directions.

In an exemplary embodiment, the quantity of antenna arrays may be eight. Any two adjacent antenna arrays are evenly distributed on the circumference centered on the omnidirectional antenna, at an interval of 45 degrees. However, the quantity of antenna arrays included in the phased array antenna in the present disclosure is not limited here.

In an exemplary embodiment, an omnidirectional antenna and the phased array antenna may be configured to transmit signals of different frequencies or frequency bands, and the normal transmission of another signal may be guaranteed when one signal transmitted by the transmitting antenna system is interfered by a co-channel transmitter, thereby improving the reliability of wireless communication.

In an exemplary embodiment, a transmitting antenna system may further include a first transmitter, a second transmitter and one or more power dividers; the first transmitter is connected to a phased array antenna through the one or more power dividers, and the second transmitter is connected to an omnidirectional antenna. By providing a power divider between a first transmitter and a phased array antenna, one signal of the first transmitter may be provided to a plurality of antenna arrays.

In an exemplary embodiment, a transmitting antenna system further includes a plurality of power amplifiers; a phased array antenna further includes a plurality of phasers which are connected to antenna arrays in an one-to-one correspondence; each power amplifier is connected between a power divider and a phaser. By providing a power amplifier between a power divider and a phaser, the energy loss caused by the wastage of the power divider may be compensated.

In an exemplary embodiment, a power divider is a duplex power divider. By adopting a duplex power divider, the structure of the transmitting antenna system is simplified and the cost is reduced. However, the types of the power divider are not limited in the embodiment of the present disclosure.

In an exemplary embodiment, a transmitting antenna system may further include a control circuit, which is respectively connected to a power amplifier and the phaser, and the control circuit is configured to control the on-off and gain amplitude of the power amplifier and provide phase shift data to a phaser.

In an exemplary embodiment, an omnidirectional antenna may be an omnidirectional monopole antenna. However, the types of the omnidirectional antenna are not limited in the embodiment of the present disclosure.

The transmitting antenna system according to the disclosed embodiments will be illustrated by examples below.

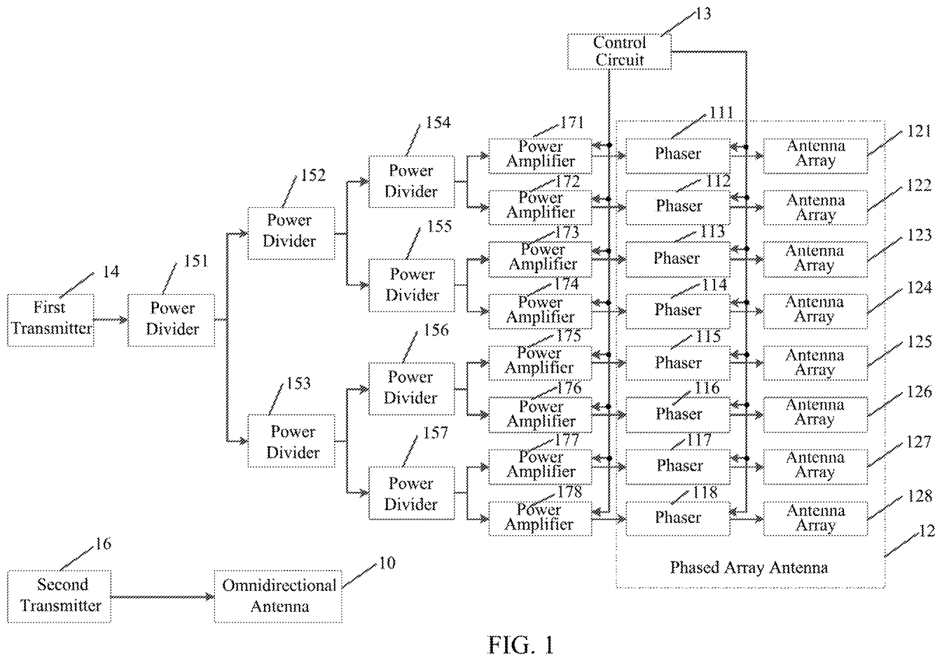

FIG. 1 is a schematic diagram of a transmitting antenna system according to an embodiment of the present disclosure. As shown in FIG. 1, a transmitting antenna system provided by the embodiment of the present disclosure includes an omnidirectional antenna 10, a phased array antenna 12, a first transmitter 14, a second transmitter 16, a plurality of power dividers and a plurality of power amplifiers. An output of the second transmitter 16 is connected to the omnidirectional antenna 10; an output of the first transmitter 14 is connected to an input of a power divider 151, two outputs of the power divider 151 are respectively connected to inputs of power dividers 152 and 153, two outputs of the power divider 152 are respectively connected to inputs of power dividers 154 and 155, and two outputs of the power divider 153 are respectively connected to inputs of power dividers 156 and 157; two outputs of the power divider 154 are respectively connected to inputs of power amplifiers 171 and 172, two outputs of the power divider 155 are respectively connected to inputs of power amplifiers 173 and 174, two outputs of the power divider 156 are respectively connected to inputs of power amplifiers 175 and 176, and two outputs of the power divider 157 are respectively connected to inputs of power amplifiers 177 and 178; the power amplifiers 171 to 178 are all connected to the phased array antenna 12.

In this example, the quantity of power dividers is seven, which are all duplex power dividers. The signal of the first transmitter 14 may be divided into eight paths by the seven duplex power dividers. In this example, a plurality of duplex power dividers are used to divide one signal energy of the first transmitter 14 into a plurality of equal signal energies, which is not only simple in structure, stable in performance, but also low in cost. However, this is not limited in the embodiment of the present disclosure. In other implementations, other types of power dividers may be used, such as quadruplex power dividers.

In this example, the phased array antenna 12 includes eight antenna arrays (such as antenna arrays 121 to 128 in FIG. 1) and eight phasers (such as phasers 111 to 118 in FIG. 1), wherein the phasers are connected to the antenna arrays in one-to-one correspondence. Herein, a phaser may control an antenna array and adjust the phase of the controlled antenna array. By adjusting the phase of an antenna array through a phaser, the main lobe direction of the antenna array radiation may be adjusted, improving the efficiency of transmitting signals by the antenna array.

In this example, eight power amplifiers are connected to phasers in one-to-one correspondence. As shown in FIG. 1, the power amplifier 171 is connected to a phaser 111, the power amplifier 172 is connected to a phaser 112, the power amplifier 173 is connected to a phaser 113, the power amplifier 174 is connected to a phaser 114, and the power amplifier 175 is connected to a phaser 115, the power amplifier 176 is connected to a phaser 116, the power amplifier 177 is connected to a phaser 117, and the power amplifier 178 is connected to a phaser 118. In this example, by providing a power amplifier before the phased array antenna 12, the energy loss caused by the wastage of the power divider may be compensated

In this example, the omnidirectional antenna 10 may be an omnidirectional monopole antenna. However, the types of the omnidirectional antenna are not limited in the embodiment of the present disclosure.

In this example, the phased array antenna 12 may be an electrically scanned phased array antenna, such as a phased array liquid crystal antenna. However, the types of the phased array antenna are not limited in the embodiment of the present disclosure. For example, in other examples, a phased array antenna may be a phased array antenna based on a micro-electro-mechanical system (MEMS) switching type phaser, a phased array antenna of a PIN diode switching type phaser, a phased array antenna of a complementary metal oxide semiconductor (CMOS) switching phaser, a phased array antenna based on a varactor reflection type phaser, or a phased array antenna loaded with linear phaser based on adjustable magnetic permeability medium such as ferroelectrics.

In this example, the first transmitter 14 and the second transmitter 16 may adopt signal transmitting chips or circuit structures commonly used in the art. This is not limited in the embodiment of the present disclosure.

FIG. 2 is a schematic top view of a transmitting antenna according to an embodiment of the present disclosure. As shown in FIG. 2, eight antenna arrays (i.e., antenna arrays 121 to 128) included in a phased array antenna 12 are disposed on the circumference centered on an omnidirectional antenna 10, and any two adjacent antenna arrays are evenly disposed circumferentially at an interval of 45 degrees. As shown in FIG. 2, the included angle between any two adjacent antenna arrays and the omnidirectional antenna 10 is 45 degrees. As shown in FIG. 2, an antenna array 127 and an antenna array 123 are located on a diameter with a clockwise angle of 0 degrees, an antenna array 122 and an antenna array 126 are located on a diameter with a clockwise angle of 45 degrees, an antenna array 121 and an antenna array 125 are located on a diameter with a clockwise angle of 90 degrees, and an antenna array 128 and an antenna array 124 are located on a diameter with a clockwise angle of 135 degrees. However, this is not limited in the embodiment of the present disclosure. For example, in other implementations, an antenna array 127 and an antenna array 123 are located on a diameter with a clockwise angle of M degrees, an antenna array 122 and an antenna array 126 are located on a diameter with a clockwise angle of 45+M degrees, an antenna array 121 and an antenna array 125 are located on a diameter with a clockwise angle of 90+M degrees, and an antenna array 128 and an antenna array 124 are located on a diameter with a clockwise angle of 135+M degrees, wherein, M is greater than 0 and less than 45.

As shown in FIG. 1, the transmitting antenna system provided in this example may further include a control circuit 13, which is respectively connected to each power amplifier and each phaser; the control circuit 13 is configured to control the on-off and gain amplitude of the power amplifier and provide phase shift data to a phaser. The control circuit 13 may control the power amplifier corresponding to a certain antenna array to turn off when it is not needed to work, and control the power amplifier corresponding to a certain antenna array to turn on when it needs to work. Furthermore, the control circuit 13 may also provide phase shift data to each phaser through a data interface to indicate the phase that each phaser needs to move. However, this is not limited in the embodiment of the present disclosure. For example, in other implementations, a control circuit may not be provided in a transmitting antenna system, and a processor in the communication device may be connected to the transmitting antenna system through one or more types of interfaces to provide the transmitting antenna system with on-off control signals and gain amplitude control signals of the power amplifier as well as the phase shift data of the phaser.

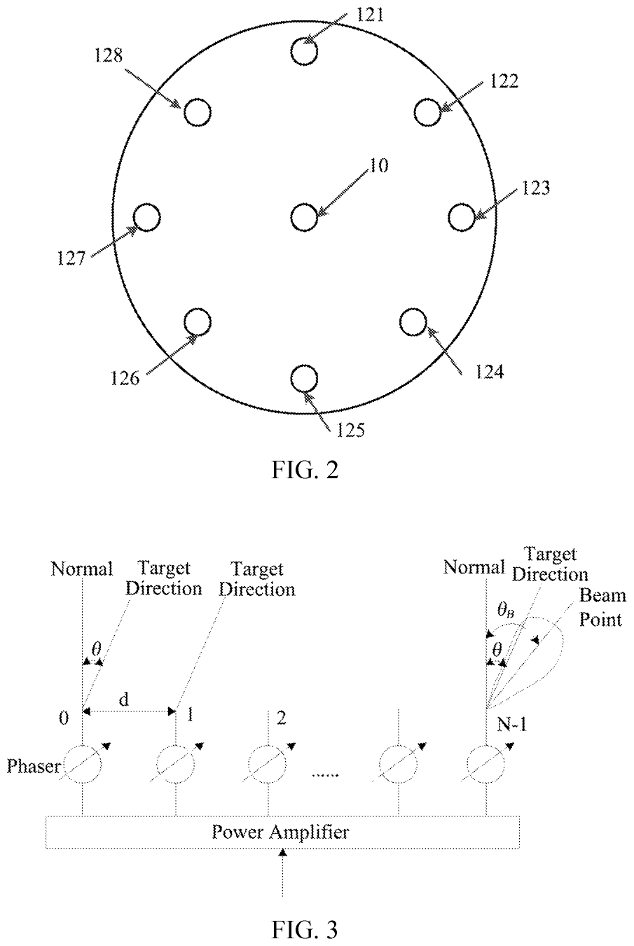

FIG. 3 is a schematic principle diagram of a phased array antenna according to an embodiment of the present disclosure. The principle of a phased array antenna includes controlling the phase and amplitude of electromagnetic waves generated by each antenna array to strengthen the intensity of electromagnetic waves in a specified direction while suppressing the intensity in other directions, thereby achieving the change of electromagnetic beam direction. The following description will take a linearly disposed phased array antenna as an example.

As shown in FIG. 3, assuming that the antenna array sub-pattern is wide enough to meet the omni-direction, a linear antenna array sub-pattern function may be described as:

$$F ( θ ) = {{\sum }^{N - 1}}_{i = 0} {a}_{i} {e}^{ji ( \frac{2 π}{λ} dsin θ - {Δϕ}_{B} )} ;$$

In the above formula, aᵢ is the amplitude weighting coefficient; Δϕ_{B} is the infeed phase difference between adjacent antenna arrays, a.k.a., the intra-array phase shift value,

$${Δϕ}_{{B}^{=}} \frac{2 π}{λ} d sin {θ}_{B}$$

and θ_{B} are the maximum antenna beam pointing; λ is the signal wavelength; d is the distance between adjacent antenna arrays; and θ is the antenna array sub-target direction; N is the total quantity of antenna arrays.

The expression of the maximum antenna beam pointing θ_{B} is:

$${θ}_{B} = arcsin ( \frac{λ}{2 π d} {Δϕ}_{B} ) .$$

It may be seen from the above formula that the maximum antenna beam direction may be changed by changing the intra-array phase shift value Δϕ_{B} between adjacent antenna arrays in the array, and Δϕ_{B} is achieved by the phaser corresponding to each antenna array.

Moreover, the field strength of each antenna array at the far end may be adjusted by changing the gain of each power amplifier, if the superimposed field strength is the strongest in a certain direction, and the gain in this direction is also the strongest.

In this example, the omnidirectional antenna 10 and the phased array antenna 12 may be configured to transmit signals of different frequencies or frequency bands. In other words, the omnidirectional antenna 10 may be configured to transmit signals of a first frequency (such as electromagnetic waves), and the phased array antenna 12 may be configured to transmit signals of a second frequency, wherein the first frequency is different from the second frequency; or, the omnidirectional antenna 10 may be configured to transmit signals of a first frequency band, and the phased array antenna 12 may be configured to transmit signals of a second frequency band, wherein the first frequency band does not coincide with the second frequency band. In this example, the transmitting antenna system may adopt a dual-frequency transmission mechanism to achieve signal transmission. During signal transmission, even if a signal of one frequency is interfered, a signal of another frequency may be received, thereby improving the reliability of wireless communication.

The transmitting antenna system provided by this example, by combining an omnidirectional antenna and s phased array antenna, can not only transmit signals at 360 degrees, but also increase the transmitting distance of signals, thereby supporting wireless communication with receivers located at a further distance. Furthermore, the transmitting antenna system provided by this example has simple structure, stable performance, simple installation and low cost.

The embodiment of the disclosure further provides a communication device including the aforementioned transmitting antenna system.

In an exemplary embodiment, a communication device provided in this embodiment may further include a processor and a data storage unit, wherein the processor is configured to control the transmitting antenna system to transmit data stored in the data storage unit.

In an exemplary embodiment, a communication device provided in this embodiment may further include a network interface, wherein a processor is configured to connect to a network switch through the network interface to receive data sent by a server.

In an exemplary embodiment, a communication device provided in this embodiment may further include a power over Ethernet (POE) unit and a power management chip, wherein the power management chip is connected to the power over Ethernet unit and a processor respectively, the power over Ethernet unit is configured to supply power to the power management chip through Ethernet, and the power management chip is configured to perform power management on the processor, a data storage unit and a transmitting antenna system.

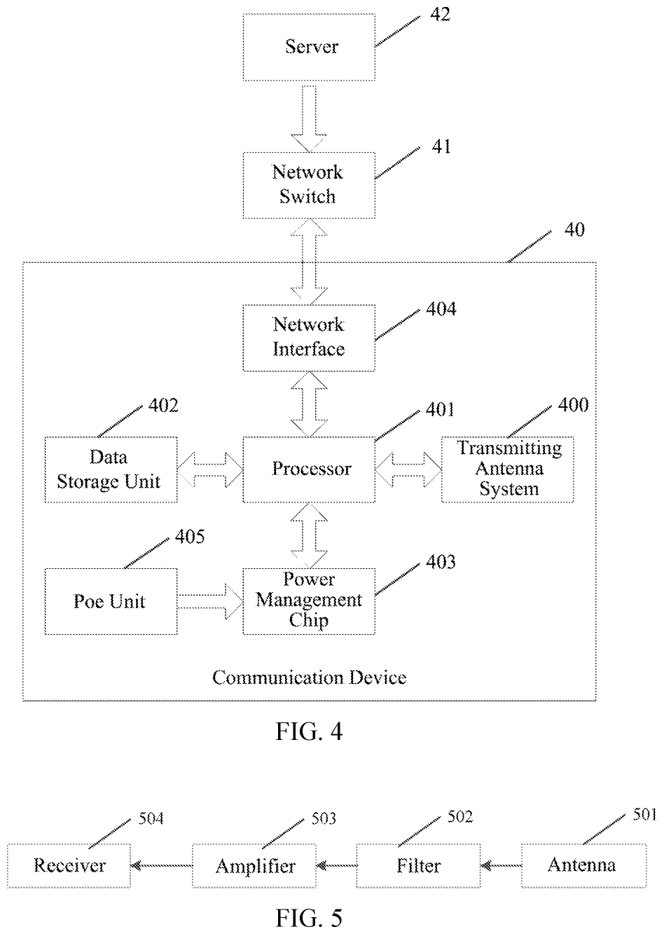

FIG. 4 is a schematic diagram of a communication device according to an embodiment of the present disclosure. A communication device provided by an embodiment of the present disclosure may be a wireless base station configured to transmit wireless signals outward. As shown in FIG. 4, a communication device 40 provided by the embodiment of the present disclosure may include a transmitting antenna system 400, a processor 401, a data storage unit 402, a power management chip 403, a network interface 404, and a POE (power over Ethernet) unit 405. The processor 401 is respectively connected to the transmitting antenna system 400, the data storage unit 402, the power management chip 403 and the network interface 404, and the POE unit 405 is connected to the power management chip 403.

The components of the communication device 40 shown in FIG. 4 are only exemplary, not restrictive, and may also have other components or omit some components based on actual needs.

In this example, the structure of the transmitting antenna system 400 may be referred to the above-mentioned embodiments, and will not be repeated here.

In this example, the processor 401 may control other components in the communication device 40 to perform desired functions. The processor 401 may be a Central Processing Unit (CPU), a Tensor Processing Unit (TPU), a Graphics Processing Unit (GPU), and other devices with data processing capability or program execution capability. In this example, the processor 401 may include a high-performance ARM-A processor, which supports the running of a Linux operating system. However, this is not limited in the embodiment of the present disclosure.

In this example, the data storage unit 402 may include any combination of one or more computer program products, and the computer program product may include one or more forms of computer-readable storage media such as volatile memory and non-volatile memory. The volatile memory may include, for example, a random access memory (RAM) or a cache memory. The non-volatile memory may include, for example, a read only memory (ROM), a hard disk, an erasable programmable read only memory (ROM), a CD-ROM, a universal serial bus (USB), or a flash memory. Various application programs and various data such as input images, and various data used or generated by the application programs may be stored in the computer-readable storage medium.

In this example, the network interface 404 may be an RJ45 interface. However, this is not limited in the embodiment of the present disclosure.

In this example, the communication device 40 may be connected to the network switch 41 through the network interface 404, so as to receive the data sent by the server 42 through the Ethernet through the network switch 41. The processor 401 may store the data received through the network interface 404 in the data storage unit 402, and transmit the data through the transmitting antenna system 400 for the receiver to receive.

In this example, the POE unit 405 may supply DC power to the communication device 40 while transmitting data through Ethernet. The power management chip 403 may provide power management for one or more components within the communication device 40. In this example, the types of the power management chip 403 are not limited.

In a wireless communication system, in order to improve the reliability of wireless communication, in addition to increasing the transmitting power of a wireless signal transmitter, the receiving sensitivity of a wireless signal receiver may also be improved. Wherein, the receiving sensitivity is the minimum signal receiving power for the receiver to correctly extract the useful signal, and the receiving sensitivity is related to the signal bandwidth, demodulation signal-to-noise ratio and noise figure.

In a wireless communication circuit system, the receiving sensitivity is −174+10 log B+NF+SNR; wherein, NF represents noise figure in decibels (db); B represents the signal bandwidth in hertz (Hz); and SNR represents the demodulation signal-to-noise ratio in decibel (dB). The value of receiving sensitivity according to the above formula is negative, and the greater the absolute value of the calculated value, the higher the receiving sensitivity. According to the above formula, the smaller the noise figure, the smaller the calculated value of receiving sensitivity, while the larger the corresponding absolute value, the higher the receiving sensitivity. That is, the receiving sensitivity may be improved by reducing the noise figure.

The noise figure NF is related to temperature coefficient T, and the correlation is as follows:

$$NF = 10 log ( 1 + \frac{T}{290} ) ;$$

T=290×(F−1); where F is noise index,

$$F = 1 {0}^{\frac{N F}{10}} .$$

The temperature coefficient of a circuit system is related to the temperature coefficient and gain of each link in the circuit system. Taking the circuit system including a tertiary link as an example, the temperature coefficient of the circuit system may be obtained according to the following formula:

$${T}_{t} = {T}_{1} + \frac{{T}_{2}}{{G}_{1}} + \frac{{T}_{3}}{{G}_{1} {G}_{2}} ;$$

in which Tt represents the temperature coefficient of the circuit system; T1 represents the temperature coefficient of the first-stage link, T2 represents the temperature coefficient of the second-stage link, T3 represents the temperature coefficient of the third-stage link, G1 represents the gain of the first-stage link, and G2 represents the gain of the second-stage link.

It may be seen that the overall temperature coefficient of the circuit system is greatly affected by the previous links in the circuit system. By reducing the temperature coefficient of previous links or increasing the gain of previous links, the overall temperature coefficient may be reduced, which reduces the overall noise figure of the circuit system to improve the receiving sensitivity.

The embodiment of the disclosure provides a receiving antenna system, which includes at least one antenna, at least one amplifier and at least one receiver; the antenna, the amplifier and the receiver are connected in one-to-one correspondence, the antenna is connected to an input of the amplifier, and an output of the amplifier is connected to the receiver; wherein the noise figure of the amplifier is smaller than that of the receiver.

The receiving antenna system provided in this embodiment improves the receiving sensitivity of the receiving antenna system by providing an amplifier with a small noise figure between the receiver and the antenna.

In the receiving antenna system provided in this embodiment, the amplifier is used as the first-stage link, the loss link is used as the second-stage link, and the receiver is used as the third-stage link; the temperature coefficient of the receiving antenna system in this embodiment is:

$${T}_{t} = {T}_{1} + \frac{{T}_{2}}{{G}_{1}} + \frac{{T}_{3}}{{G}_{1} {G}_{2}} .$$

For a receiving antenna system without an amplifier between the antenna and the receiver, with the loss link as the first-stage link (same as the second-stage link in the receiving wireless system of this embodiment) and the receiver as the second-stage link (same as the third-stage link in the receiving wireless system provided by this embodiment), the temperature coefficient of the receiving antenna system without an amplifier is:

$${T}_{t}^{′} = {T}_{1}^{′} + \frac{{T}_{2}^{′}}{{G}_{1}^{′}} = {T}_{2} + \frac{{T}_{3}}{{G}_{2}} .$$

According to the above correlation between temperature coefficient and noise figure, the smaller the noise figure, the smaller the corresponding temperature coefficient. In this embodiment, the noise figure of the amplifier is smaller than that of the receiver, which can reduce the temperature coefficient of the first-stage link, the temperature coefficient of the entire circuit system, and the noise system of the entire circuit system to improve the receiving sensitivity of the receiving antenna system. Moreover, among the commonly used amplifiers, an amplifier with low noise figure usually has higher gain, which may achieve higher gain of the first-stage link.

The following description takes the noise figure of amplifier as 2 dB, the gain as 15 dB, and the noise figure of receiver as 3.2 dB as an example. In this example, the noise figure of the amplifier is 2 dB, and the temperature coefficient of the first-stage link is:

T₁=290×(F₁−1)=290×(10^{2/10}−1)−1)=169.6K;

where F1 is the noise index of the first-stage link.

The gain of the amplifier is 15 dB, and the gain of the first-stage link where the amplifier is located is:

G₁=10^{15/10}=31.6

The second-stage link is a passive circuit, and the temperature coefficient of the secondary link is:

T₂=290×(F₂−1)=290×(IL₂−1)=290×(10^{2/10}−1)=169.6K;

where F2 is the noise index of the second-stage link and IL2 is the loss of the second-stage link.

The gain of the second-stage link is:

$${G}_{2} = \frac{1}{{IL}_{2}} = \frac{1}{{10}^{\frac{2}{10}}} = 0.63 .$$

When the noise figure of the receiver is 3.2 dB, the temperature coefficient of the third-stage link is:

T₃=290×(F₃−1)=290×(10^{3.2/10}−1)−1)=315.9K;

where F3 is the noise index of the third-stage link.

It may be seen that the temperature coefficient of the receiving antenna system with amplifier provided in this example is:

$${T}_{t} = {T}_{1} + \frac{{T}_{2}}{{G}_{1}} + \frac{{T}_{3}}{{G}_{1} {G}_{2}} = 169.6 + \frac{169.6}{31.6} + \frac{315.9}{31.6 \times 0.63} = 190.8 K ;$$

and the noise figure of the receiving antenna system with amplifier is:

$$N F = 10 log ( 1 + \frac{{T}_{t}}{290} ) = 2.2 dB .$$

On the other hand, the temperature coefficient of the receiving antenna system without an amplifier between an antenna and a receiver is:

$${T}_{t}^{′} = {T}_{2} + \frac{{T}_{3}}{{G}_{2}} = 169.6 + \frac{315.9}{0.63} = 671. K ;$$

accordingly, the noise figure of the receiving antenna system without an amplifier is:

$${NF}^{′} = 10 log ( 1 + \frac{{T}_{t}^{′}}{290} ) = 5.2 dB .$$

It may be seen from the above examples that the noise figure of the receiving antenna system provided in this embodiment is smaller than that of the receiving antenna system without an amplifier between the antenna and the receiver, and the receiving antenna system provided in the present embodiment can improve the receiving sensitivity when the signal bandwidth (B) and demodulation signal-to-noise ratio (SNR) of these two types of receiving antenna systems are the same.

In this embodiment, an amplifier is provided in front of the receiver, which may reduce the influence of the receiver on the temperature coefficient of the receiving antenna system by shifting the link stage of the receiver backward. By providing an amplifier with a smaller noise figure in front of the receiver, the temperature coefficient of the first-stage link may be reduced, thereby reducing the temperature coefficient of the entire receiving antenna system and further reducing the noise figure of the entire receiving antenna system to improve the receiving sensitivity of the receiving antenna system.

In an exemplary embodiment, the receiving antenna system may further include at least one filter, each filter is connected between an antenna and an amplifier. That is, the antennas, the filter, the amplifier and the receiver are connected in one-to-one correspondence, and the filter is connected between the antenna and amplifier. The filter is provided for filtering the interference frequency signals outside the working bandwidth range, and the reception performance of the receiving antenna system may be improved.

In an exemplary embodiment, the quantity of antennas, filters, amplifiers and receivers is plural, and different antennas are configured to receive signals of different frequencies or frequency bands. and the normal reception of another signal may be guaranteed when one signal transmitted by the transmitting antenna system is interfered by a co-channel transmitter, thereby improving the reliability of wireless communication.

FIG. 5 is a schematic diagram of a receiving antenna system according to an embodiment of the present disclosure. As shown in FIG. 5, the receiving antenna system provided by the embodiment of the present disclosure includes an antenna 501, a filter 502, an amplifier 503 and a receiver 504. The antenna 501 is connected to an input of the filter 502, an output of filter 502 is connected to an input of the amplifier 503, and an output of the amplifier 503 is connected to the receiver 504. The noise figure of the amplifier 503 is smaller than that of the receiver 504.

In this example, the receiver 504 may adopt a signal receiving chip or circuit structure commonly used in the art. This is not limited in the embodiment of the present disclosure.

In this example, the filter 502 may be configured to filter interference frequency signals outside the operating bandwidth range. The filter 502 may also be a low-loss bandpass filter. However, this is not limited in the embodiment of the present disclosure.

The embodiment of the disclosure further provides a communication device including the aforementioned receiving antenna system.

In an exemplary embodiment, a communication device provided in this embodiment may further include a processor and a data storage unit; the processor is configured to control the receiving antenna system to receive data and store the received data in the data storage unit.

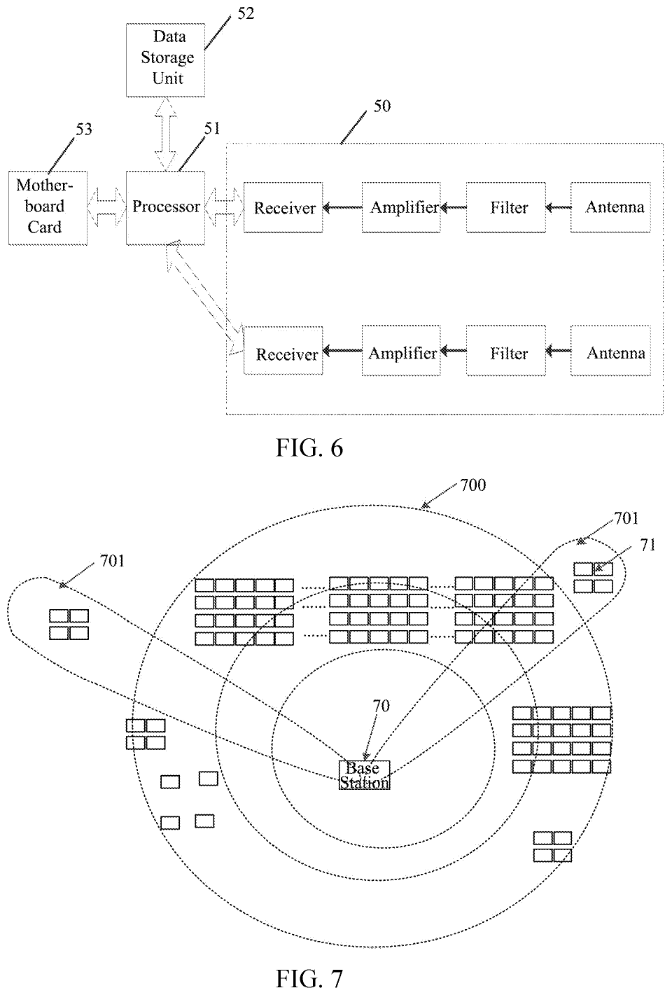

FIG. 6 is a schematic diagram of a communication device according to an embodiment of the present disclosure. A communication device provided by an embodiment of the present disclosure may be a wireless terminal configured to receive wireless signals sent by a wireless base station. As shown in FIG. 6, the communication device provided by the embodiment of the present disclosure may include a receiving antenna system 50, a processor 51, a data storage unit 52 and a motherboard card 53. The processor 51 is respectively connected to the receiving antenna system 50, the data storage unit 52 and the motherboard card 53.

The components of the communication device shown in FIG. 6 are only exemplary, not restrictive, and may also have other components or omit some components based on actual needs.

In this example, the receiving antenna system 50 includes two antennas, two filters, two amplifiers and two receivers, and the receiving antenna system 50 is configured to receive two signals with different frequencies or different frequency bands. A multi-frequency synchronous and concurrent receiving mechanism can ensure that, when one frequency is interfered, the signal of another frequency may be received, thus further ensuring the reception reliability of wireless signals and improving the reliability of communication device. The structure of the receiving antenna system 50 may be referred to the above-mentioned embodiments, and will not be repeated here.

In this example, the processor 51 may control other components in the communication device to perform desired functions. The processor 51 may be a Central Processing Unit (CPU), a Tensor Processing Unit (TPU), a Graphics Processing Unit (GPU), and other devices with data processing capability or program execution capability. However, this is not limited in the embodiment of the present disclosure.

In this example, the data storage unit 52 may include any combination of one or more computer program products, and the computer program product may include one or more forms of computer-readable storage media such as volatile memory and non-volatile memory. The volatile memory may include, for example, a random access memory (RAM) or a cache memory. The non-volatile memory may include, for example, a read only memory (ROM), a hard disk, an erasable programmable read only memory (ROM), a CD-ROM, a universal serial bus (USB), or a flash memory. Various application programs and various data such as input images, and various data used or generated by the application programs may be stored in the computer-readable storage medium.

In this example, the processor 51 may be connected to the motherboard card 53 through a serial communication standard protocol RS485 interface. However, this is not limited in the embodiment of the present disclosure.

In this example, the communication device may receive data through the receiving antenna system 50 and store the received data in the data storage unit 52. The processor 51 may control the receiving antenna system 50 to receive data and store the received data in the data storage unit 52.

In an application scenario, a communication device shown in FIG. 4 may be a wireless base station configured to transmit wireless signals, and a communication device shown in FIG. 6 may be a display device configured to receive wireless signals. Since the wireless base station combines an omnidirectional antenna and a high-gain phased array antenna, it may expand the wireless communication distance and support directional signal transmission, so as to support the remote display device to receive wireless signals. Moreover, the wireless base station adopts the multi-frequency synchronous transmission mechanism, which may reduce the interference of co-channel transmitters. And since the display device adopts a filter to suppress out-of-band interference signals and an amplifier with low noise figures, it may improve the reception performance and ensure the receiving reliability. Moreover, the display device also adopts a multi-frequency receiving mechanism, which may further ensure the receiving reliability.

FIG. 7 is a schematic diagram of antenna directivity coverage of a transmitting antenna system in an aforementioned application scenario. In this example, as shown in FIG. 7, the electromagnetic waves emitted by the wireless base station 70 may cover display devices in most areas (such as display devices in area 700 shown in FIG. 7) through an omnidirectional antenna, and may cover display devices 71 at a farther distance (such as display devices in area 701 shown in FIG. 7) through a phased array antenna.

The embodiment of the disclosure further provides a communication device including the aforementioned transmitting antenna system and receiving antenna. Other structure of the transmitting antenna system and the receiving antenna system may be referred to the above-mentioned embodiments, and will not be repeated here.

Those skilled in the art may understand that the analog devices and circuits such as antennas, power dividers, power amplifiers, phasers, receivers, transmitters, amplifiers, filters, etc. used in the present disclosure are limited by the preparation process and processing accuracy in actual systems, and the electrical characteristics of the same devices or circuits may not be perfectly identical. In actual implementation, some auxiliary circuits, such as adjustable attenuators and adjustable phasers, may be added to overcome the problems of non-ideal and unmatched actual devices and circuits. And the auxiliary circuits are within the protection scope of the present disclosure regardless of their types.

In the description of the present disclosure, it should be understood that an orientation or position relationship indicated by the terms “middle”, “upper”, “lower”, “front”, “rear”, “vertical”, “horizontal”, “top”, “bottom”, “inner”, “outer” and the like is based on the orientation or position relationship shown in the accompanying drawings, which is only for the convenience of describing the present disclosure and simplifying the description, rather than indicating or implying that the apparatus or element referred to must have the specific orientation, or be constructed and operated in the specific orientation, and thus cannot be interpreted as a limitation on the present disclosure.

In the description of the embodiments of present disclosure, unless otherwise clearly specified and defined, the terms “install”, “connect” and “link” should be broadly interpreted, for example, it may be connected fixedly or connected detachably, or integrated, it may be a mechanical connection or an electrical connection, it may be directly connected, or may be indirectly connected through an intermediate medium, it may be an internal connection between two elements. Those of ordinary skills in the art may understand the specific meanings of the above terms in the present disclosure according to real-life situations.

Although the embodiments disclosed in the present disclosure are as described above, the described contents are only the embodiments for facilitating understanding of the present disclosure, which are not intended to limit the present disclosure. Any person skilled in the art to which the present disclosure pertains may make any modifications and variations in the form and details of implementation without departing from the spirit and scope of the present disclosure. Nevertheless, the scope of patent protection of the present disclosure shall still be determined by the scope defined by the appended claims.

What is claimed is:

1. A transmitting antenna system, comprising
an omnidirectional antenna and a phased array antenna, wherein the phased array antenna comprises a plurality of antenna arrays which are disposed on the circumference centered on the omnidirectional antenna, and the interval between any two adjacent antenna arrays is the same.

2. The transmitting antenna system according to claim 1, wherein the omnidirectional antenna and the phased array antenna are configured to transmit signals of different frequencies or frequency bands.

3. The transmitting antenna system according to claim 1, further comprising: a first transmitter, a second transmitter and one or more power dividers; wherein the first transmitter is connected to a phased array antenna through the one or more power dividers, and the second transmitter is connected to an omnidirectional antenna.

4. The transmitting antenna system according to claim 3, further comprising: a plurality of power amplifiers; wherein the phased array antenna further comprises a plurality of phasers which are connected to the antenna arrays in an one-to-one correspondence; and each power amplifier is connected between a power divider and a phaser.

5. The transmitting antenna system according to claim 3 4, wherein the power divider is a duplex power divider.

6. The transmitting antenna system according to claim 4, further comprising: a control circuit which is respectively connected to a power amplifier and a phaser, wherein the control circuit is configured to control the on-off and gain amplitude of the power amplifier and provide phase shift data to the phaser.

7. The transmitting antenna system according to claim 1, wherein the quantity of antenna arrays is eight.

8. The transmitting antenna system according to claim 1, wherein the omnidirectional antenna is an omnidirectional monopole antenna.

9. A communication device, comprising the transmitting antenna system according to claim 1.

10. The communication device according to claim 9, further comprising: a processor and a data storage unit, wherein the processor is configured to control the transmitting antenna system to transmit the data stored in the data storage unit outward.

11. The communication device according to claim 10, further comprising: a network interface, wherein the processor is configured to connect to a network switch through the network interface to receive data sent by a server.

12. The communication device according to claim 10, further comprising: a power over Ethernet unit and a power management chip, wherein the power management chip is connected to the power over Ethernet unit and the processor respectively, the power over Ethernet unit is configured to supply power to the power management chip through Ethernet, and the power management chip is configured to perform power management on the processor, the data storage unit and the transmitting antenna system.

13. A receiving antenna system, comprising at least one antenna, at least one amplifier and at least one receiver; wherein the antenna, the amplifier and the receiver are connected in one-to-one correspondence, the antenna is connected to an input of the amplifier, and an output of the amplifier is connected to the receiver; wherein the noise figure of the amplifier is smaller than that of the receiver.

14. The receiving antenna system according to claim 13, further comprising at least one filter, wherein each filter is connected between an antenna and an amplifier.

15. The receiving antenna system according to claim 14, wherein the quantity of the antennas, the filters, the amplifiers and the receivers is plural, and different antennas are configured to receive signals of different frequencies or frequency bands.

16. A communication device, comprising the receiving antenna system according to claim 13.

17. The communication device according to claim 16, further comprising a processor and a data storage unit; wherein the processor is configured to control the receiving antenna system to receive data and store the received data in the data storage unit.

18. The transmitting antenna system according to claim 4, wherein the power divider is a duplex power divider.

19. A communication device, comprising the transmitting antenna system according to claim 2.

20. A communication device, comprising the receiving antenna system according to claim 14.
